(19) United States
(12) Patent Application Publication
(10) Pub. No.: US 2026/0209572 A1
(43) Pub. Date: Jul. 23, 2026

(54) METHOD FOR MANUFACTURING A GLASS LAMINATED LENS COMPRISING TETRAAZAPORPHYRIN DYES

(71) Applicant: LUXOTTICA S.R.L., Agordo (BL) (IT)

(72) Inventors: Francesca FEMIANI, Portici (NA) (IT); Matteo GILLI, Pescara (PE) (IT)

(21) Appl. No.: 19/138,375

(22) PCT Filed: Dec. 14, 2023
(86) PCT No.: PCT/IB2023/062653

§ 371 Date: Jun. 12, 2025

(30) Foreign Application Priority Data
Dec. 15, 2022 (IT) 102022000025686

(51) Int. Cl. C09J 11/06; B32B 7/12; B32B 17/10; C03C 27/10; C09B 47/00; C09B 67/20; C09J 5/00; C09J 175/14

(52) U.S. Cl. CPC C09J 11/06; B32B 7/12; B32B 17/10; C03C 27/10; C09B 47/00; C09B 67/0063; C09J 5/00; C09J 175/14; B32B 2250/03; B32B 2250/40; B32B 2307/42; C09J 2400/228; C09J 2475/00

(57) ABSTRACT

The present invention relates to a method for manufacturing a laminated lens comprising the steps of: A) mixing a dye comprising at least one tetraazaporphyrin compound and at least one urethane-acrylate glue to form an adhesive dye dispersion, said dye being mixed with said glue without being previously dispersed in an organic solvent; B) laminating together a first glass cap and a second glass cap by means of at least one adhesive layer comprising said adhesive dye dispersion, said adhesive layer being interposed between said two caps.

### FIELD OF THE INVENTION

The present invention relates to a method for manufacturing a glass laminate lens comprising tetraazaporphyrin dyes.

In particular, the present invention refers to a simplified method which allows the obtaining of lenses having increased contrast color visibility (“color enhancement” effect) and anti-reflection properties.

The optical properties conferred by the method according to the present invention make said lenses suitable to be mounted, for example, in prescription glasses, sunglasses or a mask, for example a ski mask.

### BACKGROUND OF THE INVENTION

It is generally known that by adding an inorganic or organic pigment to a lens capable of absorbing light having wavelengths in a certain range, it is possible to improve the anti-reflection properties or increase the contrast between some colors perceived by the user.

For example, lenses are known in the state of the art which incorporate inorganic pigments into the glass matrix, such as compounds based on elements from the rare earth group (e.g. neodymium and erbium), which absorb visible light with wavelengths close to 585 nm, helping to reduce the sensation of eye strain due to glare and/or reflection caused by light at the aforementioned wavelengths.

Said pigments, however, are very expensive and the process for their incorporation into the glass matrix is energetically expensive and complex.

Among the compounds capable of blocking visible light with wavelengths close to 585 nm, organic dyes with a tetraazaporphyrin structure are also known.

Tetraazaporphyrins are tetrapyrrole macrocyclic compounds having a main absorption peak in the range 565 nm-605 nm. By varying the type and number of tetraazaporphyrin dyes and their relative concentration it is possible to obtain the desired color enhancement effect. These compounds, however, degrade at glass melting temperatures and, therefore, cannot be incorporated into the glass matrix of lenses. Tetraazaporphyrins are therefore used as additives to impart anti-reflection and color enhancement effects only in plastic lenses, as they can be easily incorporated into the polymer matrix of these lenses, as this has a lower melting point than that of glass.

In order to use tetraazoporphyrin dyes to replace inorganic pigments based on elements of the rare earth group in glass lenses, in U.S. Pat. No. 9,017,820A1 it is proposed to insert the aforementioned dyes inside a layer of glue placed between the two glass caps of a lens. In particular, the method described in U.S. Pat. No. 9,017,820A1 involves the preliminary dissolution of said dyes in an organic solvent, followed by mixing the solution containing the dyes thus formed with a solvent-free glue. The adhesive mixture containing the dyes thus obtained is then used to form the adhesive layer through which the glass caps are laminated.

According to what is reported in U.S. Pat. No. 9,017,820A1, the dissolution of the dyes in the organic solvent is a necessary operation, as it is not possible to uniformly dissolve or disperse the tetraazaporphyrin dye directly in the adhesive layer at the required concentrations, since said layer is very thin. This drawback, it is stated, compromises the effectiveness of tetraazaporphyrin dyes in terms of color enhancement and anti-reflection effects. It appears evident, however, that the use of tetraazaporphyrin organic dyes according to the teaching of U.S. Pat. No. 9,017,820A1 is quite complex and laborious due to the need to pre-dissolve them in an organic solvent before mixing them with the glue.

Therefore, there is a need to find simpler alternative methods that allow the use of organic dyes, such as tetraazaporphyrin compounds, to create laminated glass lenses with anti-reflection and color enhancement properties.

### SUMMARY OF THE INVENTION

The Applicant has now surprisingly found that the drawbacks of the prior art can be overcome by uniformly dispersing the tetraazaporphyrin dyes in a urethane-acrylate type glue, so as to form an adhesive dispersion of dye that can be used as an adhesive to laminate two or more glass caps together which form a laminated lens.

The dyes, in the solid state of powder, can be uniformly dispersed directly in the urethane-acrylate glue, in an effective quantity to give the laminated lens the effect of color enhancement and/or contrast enhancement and/or anti-reflection, without requiring any pre-dissolution in an organic solvent. The production process of the laminated lens is thus simpler and quicker to implement than the prior art.

Furthermore, said glue allows the formation of an optically transparent adhesive layer, substantially inert and having an adequate adhesive and cohesive strength to keep the glass caps joined together and possibly a layer of polarizing film interposed between them.

The present invention therefore refers to a method for manufacturing a laminated lens comprising the steps of:
A) mixing a dye comprising at least one tetraazaporphyrin compound and at least one urethane-acrylate glue to form an adhesive dye dispersion, said dye being mixed with said glue without being previously dispersed in an organic solvent;
B) laminating together a first glass cap and a second glass cap by means of at least one adhesive layer comprising said adhesive dye dispersion, said adhesive layer being interposed between said two caps.

Further characteristics of the method according to the present invention are the subject of the dependent claims.

### DETAILED DESCRIPTION OF THE INVENTION

The method object of the present invention therefore allows to obtain laminated glass lenses in which the tetraazaporphyrin dyes are directly dispersed in the urethane-acrylate glue, thus avoiding the process of pre-dispersion of them in a solvent.

The mixing of the urethane-acrylate glue with the tetraazaporphyrin dyes and possible other additives, such as UV-blocking compounds, can take place by means of techniques and machinery known in the art.

The tetraazaporphyrin (TAP) dyes that can be used for the purposes of the present invention are compounds known to a person skilled in the art and commercially available.

Examples of tetraazaporphyrin dyes that can be used for the purposes of the present invention are the dyes of formula 1 and 2 described in U.S. Pat. No. 9,017,820A1.

In an advantageous embodiment, the dyes used are, for example, the compounds of the ABS Dyes line marketed under the Exciton® brand by Luxottica®. Furthermore, in order to guarantee a uniform distribution of the dyes in the glue, it is preferable that they are used in the form of powder characterized by a particle size distribution having a D50 value of less than 100 μm, preferably less than 75 μm (measured by DLS).

Preferably, said dyes are dispersed in the urethane-acrylate glue in an amount of 0.1% to 2% by weight with respect to the weight of the glue, preferably in an amount of 0.5 to 1.5% by weight.

The urethane-acrylate glues usable for the purposes of the present invention are glues known to a person skilled in the art and commercially available. Preferably, the urethane-acrylate glue is a photocross-linkable glue, for example by radiation in the UV and/or Vis spectrum.

For the purposes of the present invention, UV radiation means electromagnetic radiation having a wavelength in the range 280 nm-380 nm (UV).

For the purposes of the present invention, Vis radiation means electromagnetic radiation having a wavelength in the range 380 nm-780 nm (Vis).

Preferably, the urethane-acrylate glue can be any commercially available urethane-acrylate glue.

Preferably, the urethane-acrylate glue has a viscosity at +25° C. of 450-650 mPa·s, measured using a Brookfield RVT viscometer, Spindle 2, at 20 revolutions per minute (RPM).

Generally, urethane-acrylate glues comprise at least one multifunctional polyisocyanate, at least one reactive acrylate monomer and at least one photoinitiator.

Advantageously, the multifunctional polyisocyanate is an acrylated polyisocyanate, preferably a triacrylated polyisocyanate, even more preferably it consists of the compound tris(2-hydroxyethyl)isocyanurate triacrylate.

Once the polymerization of the glue monomers is complete, the polymer obtained is characterized by one or more of the following properties: hardness (Hardness shore D (ASTM D2240): 60-75); tensile strength (ASTM D638: 16-22 N/mm²); elongation at break (30-70%).

Preferably the reactive monomers are acrylate and/or methacrylate monomers, even more preferably said monomers are chosen from 2-hydroxyethyl methacrylate (HEMA), isobornyl acrylate and mixtures thereof.

The photoinitiator is a compound capable of directly absorbing incident light and fragmenting to form free radicals capable of starting the polymerization reaction with the formation of the final adhesive layer. Preferably, the photoionizer is phenyl bis(2,4,6-trimethylbenzoyl)-phosphine oxide.

In one embodiment, the urethane-acrylate glue may also comprise one or more solvents, for example 2-methoxy-1-methylethyl acetate (PMA).

The urethane-acrylate glue may also include one or more UV-blocking compounds, for example to provide eye protection by filtering ultraviolet rays. The UV-blocking compound can be, for example, benzotriazole or one of its derivatives, which is able to block UV light up to wavelengths of 400 nm.

Alternatively, the lenses may comprise a UV-blocking layer separate from the adhesive layer, for example in the form of a coating layer.

Furthermore, the glass caps can be neutral or colored, for example by dispersing pigments capable of blocking UV radiation in the glass matrix.

It is certainly advantageous to be able to have a color enhancing effect without resorting to the use of compounds of elements belonging to the rare earth group (very expensive). However, if desired, it is still possible to include them in the glass matrix of the caps that form the lens.

The thickness of the glass cap is typically around 1 mm, if used for the production of non-prescription glasses, such as sunglasses. If the lens is instead used for the production of prescription glasses, glass caps can be used each having a thickness of up to 2 cm.

Preferably, the thickness of a glass cap is in the range of 0.70 mm-1.5 mm.

The glass that makes up the lens caps can be of a known material, such as soda-lime glass, borosilicate glass, or crown glass.

The lenses obtained through the method of the present invention can include a polarizing film placed between the glass caps.

Polarizing films improve the anti-reflection properties of the lens. They can be thermoplastic films of the type known to a person skilled in the art. For example, in one embodiment the polarizing film comprises at least one polyvinyl alcohol film and an iodine-based polarizing agent.

The lamination of glass lenses can take place using techniques and machinery known in the art.

In the event that the laminated lens does not include any polarizing film, the adhesive dye dispersion can be applied to one or both facing surfaces of the two glass caps.

In another embodiment, the lenses may comprise a transparent, non-functionalized (e.g. non-polarizing) thermoplastic film interposed between the glass caps.

If a thermoplastic, polarizing or non-functionalized film is present, the adhesive dye dispersion can be spread on both faces of the aforementioned film which is then laminated between the glass caps.

Preferably, the adhesive dye dispersion is applied in such a quantity as to create an adhesive layer with a thickness of between 20 and 40 μm, more preferably about 30 μm.

In the event that the laminated lens includes at least one polarizing film, in one embodiment, the adhesive dye dispersion is applied on both faces of the polarizing film, forming two respective adhesive layers on it, each interposed between the polarizing film and a glass cap.

In an alternative embodiment, the adhesive dye dispersion comprising tetraazaporphyrin compounds is applied only on one face of the polarizing film, while on the face of the film opposite to the one on which the adhesive dye dispersion is applied, a layer of glue is applied, preferably a urethane-acrylate glue of the same type as that which forms the aforementioned dispersion, but without tetraazaporphyrin dyes.

In a further embodiment, in the case in which the lens includes at least one polarizing film, the adhesive dispersion comprising the tetraazaporphyrin dyes can be applied on the faces of the glass caps facing the polarizing film.

The following example is provided for the sole purpose of illustrating the present invention and must not be understood as limiting the scope of protection defined by the attached claims.

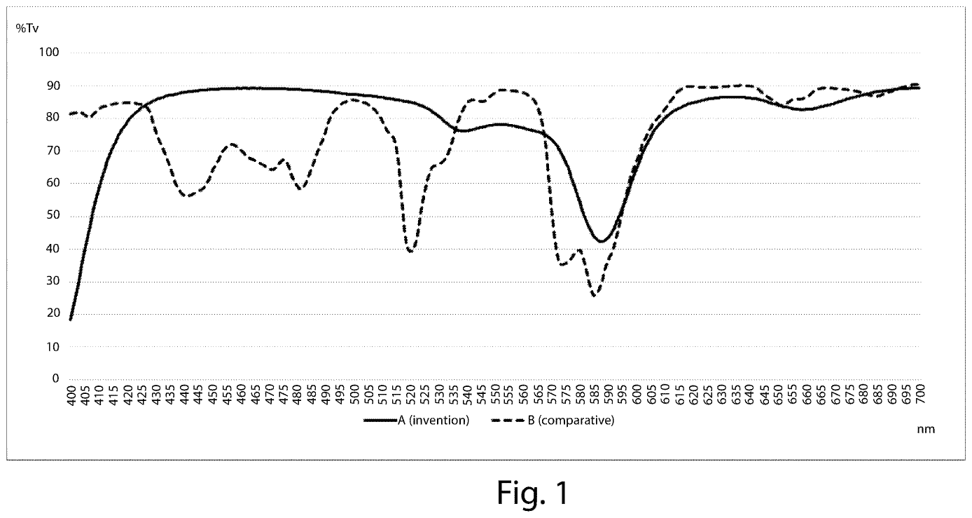

In the examples, reference will also be made to the attached FIG. 1 which reports the transmittance spectrum (%Tv) of: (A) a comparative sample made up of a glass cap (0.85 mm thick) containing rare earth oxides dispersed in the glass matrix; (B) a glass cap coated with an adhesive layer according to the invention.

### EXAMPLE 1

An adhesive dye dispersion was prepared by mixing 1 g of tetraazaporphyrin dye and 100 g of “UV30-26” urethane-acrylate glue (Loxeal Srl, Italy). The dispersion obtained is perfectly homogeneous and suitable for use in laminating glass lenses. The adhesive dye dispersion was applied to one face of a polyvinyl alcohol polarizing film to form a 30 μm adhesive layer.

A glass cap (0.85 mm thick) was applied to the adhesive layer and the assembly was then exposed to the radiation of a UV lamp to harden the glue. Subsequently, on the face of the polarizing film opposite to that engaged with the first glass cap, a second portion of the adhesive dye dispersion was applied, so as to form a second adhesive layer of 30 μm. A second glass cap comprising inorganic pigments capable of substantially blocking the transmission of light radiation with a wavelength of less than 400 nm was then laminated onto the second adhesive layer. The laminate lens thus obtained was subjected to a hardening phase of the second adhesive layer, with the same methods used for the first adhesive layer.

The final laminated lens (L1) is therefore composed of the following layers:
1) first glass cap (outer cap),
2) first adhesive layer comprising tetraazaporphyrin dyes,
3) polarizing film,
4) second adhesive layer comprising tetraazoporphyrin dyes,
5) second glass cap (internal cap).

To verify the effectiveness of the present invention, the following transmittance measurements (%Tv) were carried out. FIG. 1 shows the transmittance spectrum (%Tv) of:
sample A (invention) consisting of a glass cap (0.85 mm thick) without inorganic rare earth pigments, comprising a hardened adhesive layer applied on only one of the two faces of the cap. Sample A corresponding to the union of layers 1) and 2) of the L1 laminate lens;
sample B (comparative) formed from a glass cap (0.85 mm thick) with color enhancement properties imparted using inorganic pigments based on rare earths.

The spectrum shows a pronounced absorption peak positioned at approximately 580 nm for sample A (according to the invention) which is substantially coincident with that of the reference sample B, thus confirming the effective incorporation of the dye into the adhesive layer interposed between the two lens caps and its effectiveness in carrying out the desired color enhancement action.

1. Method for manufacturing a laminated lens comprising the steps of:
A) mixing a dye comprising at least one tetraazaporphyrin compound and at least one urethane-acrylate glue to form an adhesive dye dispersion, said dye being mixed with said glue without being previously dispersed in an organic solvent;
B) laminating together a first glass cap and a second glass cap by means of at least one adhesive layer comprising said adhesive dye dispersion, said adhesive layer being interposed between said two caps.

2. Method according to claim 1, wherein said adhesive dye dispersion is applied on one or both faces of a transparent thermoplastic film.

3. Method according to claim 1, wherein said step B comprises:
applying said adhesive dye dispersion on at least one face of a polarizing film, forming at least one adhesive layer;
laminating said first cap and said second cap together by interposing said polarizing film comprising said at least one adhesive layer between them.

4. Method according to claim 3, wherein said adhesive dye dispersion is applied on both faces of said polarizing film.

5. Method according to claim 1 wherein said laminated lens does not include a polarizing film and said adhesive dye dispersion is applied on one or both facing surfaces of said two caps, forming, respectively, one or two adhesive layers interposed between said two caps.

6. Method according to claim 1, wherein said tetraazaporphyrin compounds are dispersed in said urethane-acrylate glue in an amount from 0.1 to 2% by weight with respect to the weight of the glue, preferably in an amount from 0.5 to 1.5% by weight.

7. Method according to claim 1, wherein said at least one adhesive layer has a thickness of between 20 and 40 μm, preferably about 30 μm.

8. Method according to claim 1, wherein said urethane-acrylate glue is a photo-crosslinkable glue, preferably by irradiation with UV and/or Vis radiation.

9. Method according to claim 1, wherein said urethane-acrylate glue comprises at least one multifunctional polyisocyanate, at least one reactive acrylate monomer and at least one photoinitiator.

10. Method according to claim 1, wherein said urethane-acrylate glue comprises at least one UV-blocking compound.

11. Method according to claim 1, wherein said tetraazaporphyrin compounds are dispersed in said urethane-acrylate glue in powder form having a particle size distribution with a value of D50 lower than 100 μm, preferably lower than 75 μm.
